(19) United States
(12) Patent Application Publication
(10) Pub. No.: US 2004/0054709 A1
(43) Pub. Date: Mar. 18, 2004

(54) Assessment of capability of computing environment to meet an uptime criteria

(76) Inventor: Charles E. Bess, McKinney, TX (US)

Correspondence Address: David G. Wille, Esq., Baker Botts L.L.P., Suite 600, 2001 Ross Avenue, Dallas, TX, 75201-2980, US

(21) Appl. No.: 10/243,862

(22) Filed: Sep. 13, 2002

(51) Int. Cl. G06F 15/16

(52) U.S. Cl. 709/200

(57) ABSTRACT

A technique for addressing whether a computing environment is likely to meet an uptime criteria involves evaluating plural predetermined criteria, identifying an action based on the evaluation, and then implementing the action. A variation involves evaluating the predetermined criteria, and then generating a report with an assessment about the capability of the environment to meet the uptime criteria. Still another variation involves evaluating the predetermined criteria, determining a respective numerical value for each criteria, applying weights to the numerical values, and adding up at least some of the weighted values in order to obtain an assessment value.

### STATEMENT REGARDING COPYRIGHT RIGHTS

A portion of this patent disclosure is material which is subject to copyright protection. The copyright owner has no objection to the facsimile reproduction by anyone of the patent document or the patent disclosure, as it appears in the Patent and Trademark Office patent file of records, but otherwise reserves all copyright rights whatsoever.

### TECHNICAL FIELD OF THE INVENTION

This invention relates in general to computing environments that have a criteria for high availability and, more particularly, to techniques for assessing whether a given computing environment is likely to satisfy a criteria for high availability.

### BACKGROUND OF THE INVENTION

Computing environments, including software, are often subject to a criteria for a relatively high degree of availability, which is also commonly referred to as an “uptime” criteria. For example, there might be a criteria that a given application program must be available for users 24 hours a day, 7 days a week, which represents an uptime criteria of 100%. More typically, a few hours would be set aside once per week, during which availability of the application program is not guaranteed, so that maintenance or upgrades can be performed when the need arises. Other than the maintenance window, the program should theoretically be available all of the time. As a practical matter, however, there will be unplanned events such as power failures which are unpredictable and which can cause the program to be unavailable during at least a part of the time outside than the maintenance window. Consequently, an application program may be subject to an uptime criteria which defines the level of availability expected outside the maintenance window notwithstanding the occurrence of unplanned events. For example, a high availability program may have a specified uptime criteria on the order of 99.7%.

There are a variety of reasons of why an application program might be subject to a relatively high uptime criteria. As one example, the owner of a computer system might enter into a contract with one or more business entities, under which the business entities are granted some form of access to a specified application program. The contract may specify that the application program must be available to the business entities during specified time periods, or for a specified percentage of the time. If the availability of the application program during actual use did not satisfy the uptime criteria specified in the contract, the owner could find itself in breach of its contractual obligations, and thus subject to legal liability for damages.

As a different example, the application program might contain information relating to patients in a hospital, and thus might need to be available on an almost continuous basis, in order to permit the patient information to be accessed quickly and efficiently when needed. In some situations, such as an emergency, the life of a patient could depend on the ability of medical personnel to promptly access information about that patient which is in the application program. It will be recognized that there are a variety of other reasons why an uptime criteria could become associated with a given application program.

Although two application programs may both be put into production use, and may both initially function in a manner meeting a high uptime criteria, there may be circumstances that cause one program to be far more likely than the other to fail to meet its uptime criteria. Traditionally, however, entities have paid little attention to assessment of the risk that there might be circumstances which could potentially cause a given application program to fail to meet its uptime criteria.

### SUMMARY OF THE INVENTION

From the foregoing, it may be appreciated that a need has arisen for a suitable technique for assessing whether a computing environment is likely to meet a specified uptime criteria. A first form of the present invention involves: evaluating each of a plurality of predetermined criteria relating to capability for a computing environment to meet a specified uptime criteria; identifying as a function of the evaluating step an action intended to improve the capability for the conputing environment to meet the uptime criteria; and implementing the action.

A different form of the invention involves: evaluating each of a plurality of predetermined criteria relating to capability for a computing environment to meet a specified uptime criteria; and generating a report containing an assessment result which is a function of information developed during the evaluating step and which represents an assessed capability for the computing environment to meet the specified uptime criteria.

Yet another form of the invention involves: evaluating each of a plurality of predetermined criteria relating to capability for a computing environment to meet a specified uptime criteria, including determination of a respective numerical value for each predetermined criteria; introducing the numerical values into a computer program which includes a plurality of predetermined weights that each correspond to a respective predetermined criteria; causing the computer program to apply each weight to the corresponding numerical value in order to obtain a plurality of weighted values; and causing the computer program to calculate an assessment result that includes at least one assessment value which is a function of at least two of the weighted values.

Still another form of the invention involves a computer-readable medium encoded with a computer program which is operable when executed to: accept as input a plurality of numerical values that were each determined by evaluating a respective one of a plurality of predetermined criteria relating to capability for a computing environment to meet a specified uptime criteria; maintain a plurality of predetermined weights which each correspond to a respective predetermined criteria; apply the predetermined weights to the corresponding numerical values to obtain a plurality of weighted values; and calculate an assessment result having at least one assessment value which is a function of at least two of the weighted values.

### BRIEF DESCRIPTION OF THE DRAWINGS

A better understanding of the present invention will be realized from the detailed description which follows, taken in conjunction with the accompanying drawings, in which:

FIG. 1 is a block diagram of an apparatus in the form of a computer system configured to execute a program that carries out part of a procedure which embodies aspects of the present invention; and

FIG. 2 is a flowchart showing a sequence of successive stages in the procedure which embodies aspects of the present invention.

### DETAILED DESCRIPTION OF THE INVENTION

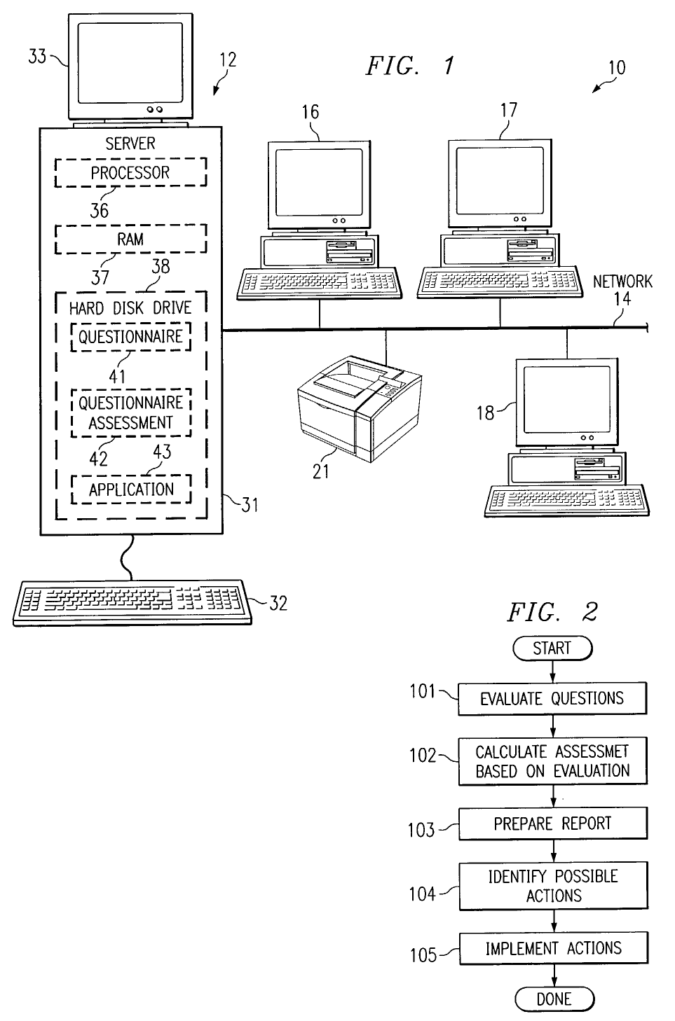

FIG. 1 is a block diagram of an apparatus in the form of a computer system 10. The computer system 10 includes a network server 12 coupled through a network 14 to a plurality of workstations 16-18 and a printer 21. Although FIG. 1 shows one server 12, three workstations 16-18 and one printer 21, this configuration is exemplary, and a wide variety of changes could be made to the system 10 without departing from the scope of the present invention.

In the disclosed embodiment, the hardware of the network server 12 is a device which can be obtained commercially, for example from Dell Computer Corporation of Austin, Tex. However, a variety of other existing and custom computer hardware systems could alternatively be used for the server 12.

The server 12 includes a system unit 31, a keyboard 32, and a display 33. The keyboard 32 permits a user to input information into the server 12. The keyboard could be replaced by or supplemented with some other type of input device, such as a pointing device of the type commonly known as a mouse or a trackball. The display 33 is a cathode ray tube (CRT) display, but could alternatively be some other type of display, such as a liquid crystal display (LCD) screen. The display 33 serves as an output device, which permits software to present information in a form in which it can be viewed by a user.

The system unit 31 of the server 12 includes a processor 36 of a known type, for example a processor of the type which can be obtained under the trademark PENTIUM from Intel Corporation of Santa Clara, Calif. However, it would alternatively be possible for the processor to be any other suitable type of processor. The system unit 31 also includes some random access memory (RAM) 37, which the processor 36 can use to store a computer program that it is executing, and/or to store data being processed by a program. The system unit 31 also includes a hard disk drive (HDD) 38, which is a device of a known type, and which can store data and/or executable programs. In the disclosed embodiment, the information stored in the HDD 38 includes a questionnaire 41, a questionnaire assessment program 42, and an application program 43, each of which will be discussed in more detail later.

The network 14 may be any of a variety of different types of networks, including an intranet, the Internet, a local area network (LAN), a wide area network (WAN), some other type of existing or future network, or a combination of one or more of these types of networks. In the disclosed embodiment, workstations 16-18 are each a system of the type commonly known as a personal computer. The workstations 16-18 are implemented with personal computers obtained from Dell Computer Corporation of Austin, Tex., but the workstations 16-18 could alternatively be implemented with any other suitable type of computer. The printer 21 in the disclosed embodiment is a network printer of a known type that is commonly referred to as a laser printer, but could alternatively be any other suitable type of printer.

The application 43 stored on the HDD 38 is an executable program. The application program 43 can be executed by a processor having access to the HDD 38, such as the processor 36 in the server 12, or a processor in any one of the workstations 16-18. The present discussion assumes for convenience and clarity that the application program 43 is stored on the HDD 38. However, the application program 43 could alternatively be resident in and executed by an entirely different computer system, which is not capable of communicating in any way with the computer system 10 shown in FIG. 1.

It is assumed for purposes of the present discussion that the application program 43 is subject to a criteria for a high degree of availability, which is also commonly known as “uptime” criteria. For example, it might be a criteria that the application program 43 be available for users 24 hours a day, 7 days a week, which represents an uptime criteria of 100%. More typically, a few hours would be set aside once per week, during which availability of the application program is not guaranteed, so that maintenance or upgrades can be performed when the need arises. Other than the maintenance window, the program should theoretically be available all of the time. As a practical matter, however, there will be unplanned events such as power failures which are unpredictable and which can cause the program to be unavailable during at least a part of the time outside than the maintenance window. Consequently, an application program may be subject to an uptime criteria which defines the level of availability expected outside the maintenance window notwithstanding the occurrence of unplanned events. For example, a high availability program may have a specified uptime criteria on the order of 99.7%.

There are a variety of reasons of why an application program might be subject to a relatively high uptime criteria. As one example, the owner of server 12 and application program 43 might enter into a contract with one or more business entities, under which the business entities are granted some form of access to the application program 43. The contract may specify that the application program 43 must be available to the other entities during specified time periods, or for a specified percentage of the time. If the availability of the application program 43 during actual use did not satisfy the contractual uptime criteria, the owner could find itself in breach of its contractual obligations, and subject to legal liability for damages.

As a different example, an application program might contain information relating to patients in a hospital, and thus might need to be available on an almost continuous basis, in order to permit the patient information to be accessed quickly and efficiently when needed. In some situations, such as an emergency, the life of a patient could depend on the ability of medical personnel to promptly access information about that patient which is in the application program. It will be recognized that there are other reasons why an uptime criteria could become associated with an application program.

Although two application programs may both be put into production use, and may both initially function in a manner meeting a high uptime criteria, there may be circumstances that cause one program to be far more likely than the other to fail to meet its uptime criteria. In this regard, there are a number of factors in the overall computing environment which can potentially produce unplanned problems that affect availability. Traditionally, however, entities have paid little attention to assessment of the risk that there might be circumstances which could potentially cause a given computing environment to fail to meet its uptime criteria. In the context of the present discussion, “computing environment” is used relatively broadly to refer to any factor which could affect the availability of a program, such as hardware (including network hardware), software, software development team (including ongoing enhancement work), and the various support teams for the hardware and software.

One feature of the present invention involves the provision of a defined and reliable procedure for assessing whether a given computing environment is likely to meet the uptime criteria for a given application program, and for identifying specific types of potential problems that might make it difficult for the computing environment to meet the uptime criteria. Advance action can be taken in order to reduce or eliminate the likelihood that such problems will actually occur. The assessment may be carried out on a new application for which development work is still being completed, or on an application which was completed in the past and which has already been in production use for some time. The questionnaire 41 and the questionnaire assessment program 42 are provided to facilitate such an assessment.

In more detail, the questionnaire 41 includes a plurality of different questions which relate to a variety of factors that affect the ability of a computing environment to meet the uptime criteria for an application program. The questionnaire 41 in the disclosed embodiment uses a predetermined set of 58 questions, which are set forth in the third column of TABLE 1. In the case of a computer program, availability is significantly dependent on the quality of the code, and consequently the questions place a fair degree of emphasis on review of the testing practices associated with the system. The set of 58 questions in TABLE 1 is exemplary, and relates primarily to various development and support teams and their behavior. It will be recognized that a larger or smaller number of questions could be used, and that some or all of the questions could be replaced with other questions.

TABLE 1

| CATEGORY | # | QUESTION | WEIGHT |
|---|---|---|---|
| Development | 1 | Are the development tools | 1 |
| Environment | | widely used (by at least | |
| | | 1,000 trained persons) | |
| | | within the entity supporting | |
| | | the application? | |
| | 2 | Has the software | 2 |
| | | architecture been | |
| | | independently reviewed to | |
| | | ensure it meets the user's | |
| | | uptime criteria? | |
| | 3 | Are the development servers | |
| | | in a separate location from | |
| | | the production server? | |
| | 4 | Have all application | 1 |
| | | components been used within | |
| | | the entity supporting the | |
| | | application, for other | |
| | | systems having comparable | |
| | | uptime criteria? | |
| | 5 | Does the system have built- | 1 |
| | | in collection points for | |
| | | metrics about downtime and | |
| | | performance? | |
| System | 6 | Is the system free of a 100% | 1 |
| Environment | | uptime criteria? | |
| | 7 | Is the system free of | 1 |
| | | contractual criteria | |
| | | regarding uptime? | |
| | | (If no, skip Question 8). | |
| | 8 | Is the system free of | 1 |
| | | implied uptime criteria from | |
| | | users? | |
| | 9 | Can the system meet the | 3 |
| | | uptime criteria of the user? | |
| | 10 | Do the system team and | 2 |
| | | application team agree on | |
| | | the uptime criteria? | |
| | 11 | Is the maintenance window | 1 |
| | | adequate for system and | |
| | | environmental updates? | |
| | 12 | Is this application limited | 1 |
| | | to two or fewer platforms | |
| | | (e.g. desktop, server)? | |
| | 13 | Is the system free of wide | 1 |
| | | area network (WAN) | |
| | | components? | |
| System | 14 | Are there controls within | 1 |
| Controls | | the system to ensure data | |
| | | integrity? | |
| | 15 | Are there controls within | 1 |
| | | the system to facilitate | |
| | | recovery? | |
| | 16 | Does the system maintain an | 1 |
| | | audit trail? | |
| | 17 | Does the recovery strategy | 2 |
| | | support the agreed service | |
| | | level agreement (SLA)? | |
| | 18 | Is there an accepted manual | 1 |
| | | processing strategy, to | |
| | | cover failures? | |
| | 19 | Have all relevant areas of | 1 |
| | | Technical Infrastructure | |
| | | signed off on the controls, | |
| | | including each of: (1) | |
| | | Security, (2) Service Level | |
| | | Management, (3) Operations, | |
| | | and (4) Technical Services | |
| | | (Database)? | |
| | 20 | Has a release manager been | 1 |
| | | assigned to each major | |
| | | release? | |
| | 21 | Has standard Configuration | 1 |
| | | Management been used | |
| | | throughout the system, | |
| | | including each of: | |
| | | (1) Source Code Management, | |
| | | (2) Documentation, and | |
| | | (3) Job Control? | |
| Maintenance | 22 | Is the Test strategy | 1 |
| Testing | | documented in all relevant | |
| | | aspects, including each of: | |
| | | (1) Unit | |
| | | (2) System, and | |
| | | (3) End-to-End/Model office? | |
| | 23 | Has a test plan been | 1 |
| | | developed and followed? | |
| | 24 | Have the expected results | 1 |
| | | from testing been | |
| | | documented? | |
| | 25 | Have actual testing results | 1 |
| | | been documented? | |
| | 26 | Has Unit Testing been | 1 |
| | | leveraged into Systems | |
| | | Testing? | |
| | 27 | Has System Testing been | 1 |
| | | leveraged into End-to-End | |
| | | Testing? | |
| | 28 | Have all interfaces been | 1 |
| | | tested (before any move to | |
| | | production)? | |
| | 29 | Has Testing covered each of | 1 |
| | | the following factors: | |
| | | (1) Path Coverage, | |
| | | (2) Boundary Testing, | |
| | | (3) Stubs, and | |
| | | (4) Destructive Testing? | |
| | 30 | Has Testing been subject to | 1 |
| | | detailed fault tracking? | |
| | 31 | Have all Test Faults been | 1 |
| | | resolved? | |
| User | 32 | Is the User Acceptance Test | 1 |
| Acceptance | | strategy documented? | |
| Testing | 33 | Have expected results from | 1 |
| (UAT) | | User Acceptance Testing been | |
| | | documented? | |
| | 34 | Has a User Acceptance Test | 1 |
| | | plan been developed? | |
| | 35 | Have actual results from | 1 |
| | | User Acceptance Testing been | |
| | | documented? | |
| | 36 | Does the User Acceptance | 1 |
| | | Test cover all of the | |
| | | functionality of the system? | |
| | 37 | Has User Acceptance Testing | 1 |
| | | been subject to detailed | |
| | | fault tracking? | |
| | 38 | Has the user provided | 1 |
| | | unconditional sign-off for | |
| | | User Acceptance Testing? | |
| | 39 | Has User Acceptance Testing | 1 |
| | | included testing of all | |
| | | relevant interfaces? | |
| | 40 | Is the User Acceptance Test | 1 |
| | | environment representative | |
| | | of production? | |
| | 41 | Does the user perform User | 1 |
| | | Acceptance Testing? | |
| Implementation | 42 | Has sign-off been received | 1 |
| | | for all interfaces? | |
| | 43 | Have all test phases been | 1 |
| | | signed off? | |
| | 44 | Has testing adequacy been | 1 |
| | | subject to independent | |
| | | review? | |
| | 45 | Will implementation have no | 1 |
| | | potential impact on any | |
| | | service level, including | |
| | | each of: (1) this | |
| | | application, and (2) other | |
| | | applications? | |
| | 46 | Can fallback be achieved if | 1 |
| | | a problem is identified | |
| | | during deployment? | |
| | 47 | Has fallback been tested? | 1 |
| | 48 | Has the release manager | 1 |
| | | signed off on fallback? | |
| | 49 | Has change management been | 1 |
| | | subject to peer review? | |
| | 50 | Are there other systems or | 1 |
| | | processes that will be | |
| | | affected by this change? | |
| | 51 | Have users signed off on the | 1 |
| | | Implementation Plan? | |
| | 52 | Are changes coordinated with | 1 |
| | | other major planned changes? | |
| Post | 53 | Was a post-implementation | 1 |
| Implementation | | review performed on the last | |
| Review | | major upgrade? | |
| (PIR) | 54 | Was the last major upgrade | 1 |
| | | completed on time and within | |
| | | budget? | |
| | 55 | Did all deliverables conform | 1 |
| | | to requirements? | |
| | 56 | Did the project meet | 1 |
| | | customer expectations? | |
| | 57 | Were reported faults | 1 |
| | | tracked? | |
| | 58 | Was a corrective action plan | 1 |
| | | developed for reported | |
| | | faults? | |

For the purpose of convenience in explaining the present invention, the second column of TABLE 1 includes a unique question number for each question. However, these questions can be used to practice the present invention without any question numbers. Further, as discussed later, the questions in TABLE 1 may be presented to a person in an order which is significantly different from the order shown in TABLE 1. In that event, if question numbers were actually associated with the questions, the sequence of the question numbers might correspond to the order in which the questions were presented, rather than the order shown in TABLE 1.

The questions in TABLE 1 are grouped into seven categories, which are each identified in the left column of TABLE 1. These seven categories are (1) Development Environment, (2) System Environment, (3) System Controls, (4) Maintenance Testing, (5) User Acceptance Testing (UAT), (6) Implementation, and (8) Post-Implementation Review (PIR). Each category relates to a different type of problem that could cause a computing environment to fail to meet its uptime criteria.

In more detail, the Development Environment category relates to high-level development issues associated with the system. The System Environment category relates to high-level environmental issues associated with the system. The System Controls category relates to security, audit and recoverability. An objective of the System Controls category is to ensure that attention has been given to security, audit and recoverability as an integral component of system design. The Maintenance Testing category and the User Acceptance Testing category each relate to a respective group of tasks that are often considered to be mandatory within a standard system life cycle methodology, because if a methodology is not being followed, increased risk may be incurred.

The Implementation category seeks confirmation that the application (or a change to an application) is ready for implementation, by re-confirming some points from earlier categories, and by focusing on change management and delivery. The Post-Implementation Review category relates to high-level review of the project after implementation. If a post-implementation review was not performed, it is likely that the questions in this category will be difficult to complete. In fact, if answers to the questions reveal a problem in any of the other categories, a post-implementation review should be performed to identify areas for future improvement.

The right column in TABLE 1 shows a respective weight for each question, and these weights reflect the relative importance of the various questions with respect to each other. In the disclosed embodiment, each weight is an integer value of 1, 2 or 3, but it would alternatively be possible to use some other weighting scheme. As will become evident later, a question with a weight of 2 is given twice the influence in the assessment process as a question with a weight of 1, and a question with a weight of 3 is given three times the influence in the assessment process as a question with a weight of 1.

The answers to the questions may be provided by a single person, or through a consensus decision by a team. The questions are structured so that the answer to each question is “yes” or “no”. In the disclosed embodiment, the answer to each question is recorded as a numeric value of 1 if the answer is “yes”, or a numeric value of 0 if the answer is “no”. Alternatively, the answers to the questions could be recorded in some other suitable manner. For example, the questions could be structured so that the answer to each question is one of several options on a scale ranging from strong agreement to strong disagreement, and each such option could be recorded as a respective numeric value on a scale ranging from 0-5, where 0 represents strong disagreement and 5 represents strong agreement.

Some of the specific questions in TABLE 1 will now be briefly discussed, in order to ensure that their intended thrust is clear. For example, Question 1 asks whether the development tools used to prepare the application program 43 are widely used within the entity which developed the application, such that the entity employs a specified number of persons who are trained in those particular development tools. In the case of a very large organization, and as reflected by Question 1, the specified number might be 1,000, such that the inquiry is whether there are at least 1,000 persons who are trained in the particular development tools.

Question 2 asks whether the architecture of the application program 43 has been given an independent review, in order to ensure that it meets its uptime criteria. Questions 3 asks whether the development servers are in a physical location different from the physical location of the production server. This is because, in the event of a serious problem or disaster associated with the production server, less time will typically be needed to get the application program up and running again if the development servers are in a location different from the production server.

Question 6 asks whether the system is required to be up 24 hours a day, 7 days a week, which is essentially asking whether any time has been allocated for maintenance. Question 12 asks whether the architecture of the application program is configured so that there are no more than two platforms or layers within that architecture. Questions 7 and 8 involve qualitative assessments. Question 14 asks whether there are controls within the system to ensure data integrity. An example of such a control would be a policy specifying that a given change could not be implemented unless the change has been approved by each of the persons responsible for each of the programs involved with and affected by the change. Question 17 refers to a service level agreement (SLA), which is an agreement that may specify service requirements such as response time for service in the event of a problem.

Question 19 asks whether each of several different specified areas have signed off on the implementation of the application program 43. In order for the answer to question 19 to be a “yes”, so that a 1 is recorded, the answer must be “yes” for each of the various different listed departments, including security, service level management, operations and technical services. Question 21 refers to standard configuration management considerations, which is a reference to industry standards that do not need to be discussed in detail here. The reference to source code management relates to considerations such as whether an archive is maintained, including earlier versions. The reference to job control relates to how batch jobs, if any, will be run. Question 22 refers to a “unit”, a “system” and an “end-to-end/model office”, which respectively mean a program or subroutine, the group of units making up the system, and the entire environment.

Question 29 is similar to question 19, because an answer of “yes” for the question is permitted only if there is an answer of “yes” for each of various different areas, including path coverage, boundary testing, stubs and destructive testing. The inquiries about path coverage and stubs are essentially asking if every line of code in the application 43 has been tested. The inquiry about boundary testing relates to whether all interfaces between modules and/or systems have been tested. The inquiry about destructive testing relates to whether testing has been carried out for worst case scenarios, which is sometimes known as “stress testing”. As an example, if a list is structured to hold a maximum of 100 data elements, a stress test would typically involve an attempt to put 101 data elements into that list, in order to see if the application program detects and flags the error.

Question 30 relates to whether faults detected during testing are tracked, so as to ensure that each detected fault is eventually fixed. Question 31 relates to whether all the faults detected during testing have in fact been fixed. Question 42 relates to whether all affected parties have approved what they need to approve in order to implement the application program 43, or to make any necessary change or update to the application program 43. Questions 46-48 all relate to the issue of whether, following a problem, recovery can be effected in a manner that will effectively return the system to the state it was in before the problem occurred.

FIG. 2 is a flowchart showing a sequence of blocks 101-105 that represent successive stages in a procedure for evaluating whether a given computing environment, such as an environment including the application program 43, is likely to be able to meet an associated uptime criteria. This procedure begins in block 101, where the questions in the questionnaire 41, which are set forth in TABLE 1, are evaluated and answered. The questions may all be answered by a single person, who is either in a position to know the answers to all of the questions, or who is in a position to gather information from others and then answer the questions. Alternatively, a team of several persons could cooperate in answering the questions, where each person on the team answers a subset of the questions, or where team members negotiate with each other to reach a consensus as to any given answer.

In the disclosed embodiment, the questions in the questionnaire 41 are presented electronically, and the answers are recorded electronically. In particular, the questionnaire 41 is configured as a hypertext document of the type commonly referred to as a Web page, and can be accessed with any known network browser program through the network 14, for example from any one of the workstations 16-18. The answers are then recorded in a computer file or database that can be accessed by the assessment program 42. Alternatively, the assessment program 42 could have an operational mode in which it presented the questions from the questionnaire 41 and then recorded the answers. As yet another alternative, the questionnaire 41 could be configured as a paper form on which the answers are recorded manually, and then the answers could be manually entered into the assessment program 42.

In FIG. 2, after answers to the questions in the questionnaire 41 have been recorded, activity proceeds from block 101 to block 102, where the questionnaire assessment program 42 calculates an assessment based on the answers obtained in response to the questionnaire 41, or in other words in response to the questions shown in TABLE 1. As discussed above, the answer to each question is translated into a numeric value, which is a binary 1 if the answer to the question is “yes”, or a binary 0 if the answer to the question is “no”.

The assessment program 42 takes the numeric value for each question, and multiples it by the associated weight from the right column of TABLE 1, in order to obtain a weighted value. The program 42 then adds up the weighted values separately for each of the seven categories listed in the left column of TABLE 1, in order to obtain a respective numeric assessment score for each category. The numeric score for each category is then translated into an assessment in the form of a descriptive word such as “Risky”, “Fair”, “Good”, or “Excellent”. In this regard, TABLE 2 shows how the various different numeric scores which are possible in each category can each be translated into one of these descriptive words.

TABLE 2

| | SCORE | | | | |
|---|---|---|---|---|---|
| CATEGORY | 0-2 | 3-4 | 5-6 | 7-9 | 10+ |
| Development | Fair | Good | Excellent | — | — |
| Environment | | | | | |
| System | Risky | | Fair | Good | Excellent |
| Environment | | | | | |
| System | Risky | Fair | Good | Excellent | — |
| Controls | | | | | |
| Maintenance | Risky | | Fair | Good | Excellent |
| Testing | | | | | |
| User | Risky | | Fair | Good | Excellent |
| Acceptance | | | | | |
| Testing (UAT) | | | | | |
| Implementation | Risky | | Fair | Good | Excellent |
| Post | Fair | Good | Excellent | — | — |
| Implementation | | | | | |
| Review (PIR) | | | | | |

Activity then proceeds from block 102 to block 103, where the assessment program 42 prepares a report. In the disclosed embodiment, the program 42 prints the report on the printer 21, so that it can easily be reviewed by a person. However, it would alternatively be possible to present the report to a person in some other suitable manner, for example by displaying it on the display screen of any one of the computers in the computer system 10 of FIG. 1. TABLE 3 is an example of a portion of an exemplary report.

TABLE 3

| CATEGORY | SCORE | ASSESSMENT |
|---|---|---|
| Development Environment | 5 | Excellent |
| System Environment | 4 | Risky |
| System Controls | 7 | Excellent |
| Maintenance Testing | 9 | Good |
| User Acceptance Testing (UAT) | 6 | Fair |
| Implementation | 10 | Excellent |
| Post Implementation Review (PIR) | 5 | Excellent |

The left column in TABLE 3 lists the seven categories, the middle column presents the numeric score or assessment value calculated for each category from the weighted values, and the right column shows the descriptive word assessment associated with each score, based on the translation shown in TABLE 2. A person viewing the report of TABLE 3 can immediately recognize that the “System Environment” category has been designated as “Risky”, and is thus the category in greatest need of attention in order to increase the likelihood that the computing environment which includes the application program 43 will be capable of meeting the applicable uptime criteria. Similarly, the person will recognize from the report that the “User Acceptance Testing” category has been designated as only “Fair”, and is thus also deserving of some attention in order to increase the likelihood that the computing environment meet the uptime criteria.

In addition to the information shown in TABLE 3, the report also includes a list of each of the questions which was assigned a numeric value of 0 in order to indicate an answer of “no”. These questions would be grouped by category, so as to permit a person viewing the report to easily see each potential problem which was identified for each category. Within each category, the questions could presented in an order corresponding to decreasing weights, so that questions representing problems with greater weights could be given priority over other questions. As a further alternative, the questions could be presented in different colors, where each color corresponds to a respective different weight. For example, each question with a weight of 3 might be presented in red, each question with a weight of 2 might be presented in green, and each question with a weight of 1 might be presented in black. As still another alternative, each item in the list could be a statement corresponding to a particular question, rather than the specific wording of the question itself. For example, instead of repeating the actual language of question 15 (TABLE 1), it would be possible to use a corresponding statement in the form of an action item such as: “Establish controls within the system to facilitate recovery”.

The report generated by the assessment program 42 provides real world value and an immediate benefit, for example by permitting a person to rapidly and accurately identify potential problem areas that might prevent a computing environment, such as that including the application program 43, from meeting an applicable uptime criteria.

In FIG. 2, after generation of the report, activity moves from block 103 to block 104, where one or more persons use the report to identify possible actions that will tend to increase the likelihood that the conputing environment will meet its uptime criteria. For example, with reference to question 13 in TABLE 1, if the application program 43 is currently configured to rely on WAN components, but could be reconfigured in a manner which avoids the need for WAN components, such reconfiguration might be one of the possible courses of action identified in block 104. In some cases, a course of action will be somewhat more specific than the question itself. As to question 13, for example, the course of action may be fairly specific as to precisely how the application program could be reconfigured to avoid WAN components, rather than a generalized statement that WAN components should be eliminated in some unspecified manner. In fact, two or more relatively specific courses of action might be adopted to address the single potential problem identified at a high level by any single question.

Subsequently, in block 105, people actually implement some or all the actions identified in block 104. The implementation of these actions serves to increase the likelihood that the computing environment which includes the application program 43 will meet the uptime criteria. Consequently, the procedure shown in FIG. 2 will result in a real world effect that provides a useful, concrete and tangible result.

The present invention provides a number of advantages. One such advantage is that it provides a well-defined and reliable procedure for assessing a variety of factors that can affect whether a computing environment will be capable of meeting a specified uptime criteria. A related advantage is that the result of the assessment is presented in the form of a report, which provides a clear indication of the types of problems that are likely to arise. As one aspect of this, the report is configured to provide separate assessments in each of several categories, so that a person can rapidly recognize the categories which are more likely than others to generate problems. It is advantageous where the report is configured to specify for each category a list of specific potential problems, in order to facilitate the formulation and implementation of corrective actions which may avoid some or all of those problems. Still another advantage is that, by avoiding unnecessary downtime, user satisfaction with the application program can be maintained at a high level.

Although one embodiment has been illustrated and described in detail, it will be understood that various substitutions and alterations are possible without departing from the spirit and scope of the present invention, as defined by the following claims.

What is claimed is:

1. A method comprising the steps of:
evaluating each of a plurality of predetermined criteria relating to capability for a computing environment to meet a specified uptime criteria;
identifying as a function of said evaluating step an action intended to improve said capability for said computing environment to meet said uptime criteria; and
implementing said action.

2. A method according to claim 1, including the steps of:
determining as part of said evaluating step a respective numerical value for each said predetermined criteria;
applying to each said numerical value a respective predetermined weight to obtain a respective weighted value; and
calculating an assessment result that includes at least one assessment value which is a function of at least two of said weighted values.

3. A method according to claim 2,
wherein said predetermined criteria are grouped into a plurality of mutually exclusive groups corresponding to respective different categories which each relate to capability for a computing environment to meet a specified uptime criteria; and
wherein said calculating step is carried out in a manner so that said assessment result includes a plurality of said assessment values that each correspond to a respective said category.

4. A method according to claim 3, including the step of selecting as each said category one of: development environment, system environment, system controls, maintenance testing, user acceptance testing, implementation, and post implementation review.

5. A method according to claim 1, including the steps of:
generating a report containing an assessment result which is a function of information developed during said evaluating step and which represents an assessed capability for the computing environment to meet the specified uptime criteria; and
carrying out said identifying step on the basis of said assessment result in said report.

6. A method comprising the steps of:
evaluating each of a plurality of predetermined criteria relating to capability for a computing environment to meet a specified uptime criteria; and
generating a report containing an assessment result which is a function of information developed during said evaluating step and which represents an assessed capability for the computing environment to meet the specified uptime criteria.

7. A method according to claim 6,
wherein said evaluating step includes the step of determining a respective numerical value for each said predetermined criteria; and
wherein said generating step includes the steps of:
introducing said numerical values into a computer program which includes a plurality of predetermined weights that each correspond to a respective said predetermined criteria;
causing said computer program to apply each said weight to the corresponding numerical value to obtain a plurality of weighted values;
causing said computer program to calculate said assessment result in a manner so that said assessment result includes at least one assessment value which is a function of at least two of said weighted values; and
causing said computer program to prepare said report containing said assessment result.

8. A method according to claim 7,
wherein said predetermined criteria are grouped into a plurality of mutually exclusive groups corresponding to respective different categories which each relate to capability for a computing environment to meet a specified uptime criteria; and
wherein said step of causing said computer program to calculate said assessment result is carried out in a manner so that said assessment result includes a plurality of said assessment values that each correspond to a respective said category.

9. A method according to claim 8, including the step of selecting as each said category one of: development environment, system environment, system controls, maintenance testing, user acceptance testing, implementation, and post implementation review.

10. A method according to claim 6, including the steps of:
identifying on the basis of said assessment result in said report an action intended to improve said capability for said computing environment to meet said uptime criteria; and
implementing said action.

11. A method comprising the steps of:
evaluating each of a plurality of predetermined criteria relating to capability for a computing environment to meet a specified uptime criteria, said evaluating step including the step of determining a respective numerical value for each said predetermined criteria;
introducing said numerical values into a computer program which includes a plurality of predetermined weights that each correspond to a respective said predetermined criteria;
causing said computer program to apply each said weight to the corresponding numerical value to obtain a plurality of weighted values; and
causing said computer program to calculate an assessment result that includes at least one assessment value which is a function of at least two of said weighted values.

12. A method according to claim 11, including the steps of:
identifying as a function of said evaluating step an action intended to improve said capability for said computing environment to meet said uptime criteria; and
implementing said action.

13. A method according to claim 11,
wherein said predetermined criteria are grouped into a plurality of mutually exclusive groups corresponding to respective different categories which each relate to capability for a computing environment to meet a specified uptime criteria; and
wherein said calculating step is carried out in a manner so that said assessment result includes a plurality of said assessment values that each correspond to a respective said category.

14. A method according to claim 13, including the step of selecting as each said category one of: development environment, system environment, system controls, maintenance testing, user acceptance testing, implementation, and post implementation review.

15. A method according to claim 11, including the step of causing said computer program to generate a report which includes said assessment result.

16. A computer-readable medium encoded with a computer program which is operable when executed to:
accept as input a plurality of numerical values that were each determined by evaluating a respective one of a plurality of predetermined criteria relating to capability for a computing environment to meet a specified uptime criteria;
maintain a plurality of predetermined weights which each correspond to a respective said predetermined criteria;
apply said predetermined weights to the corresponding numerical values to obtain a plurality of weighted values; and
calculate an assessment result having at least one assessment value which is a function of at least two of said weighted values.

17. A method according to claim 16,
wherein said predetermined criteria are grouped into a plurality of mutually exclusive groups corresponding to respective different categories which each relate to capability for a computing environment to meet a specified uptime criteria; and
wherein said computer program is operable when executed to carry out said calculating step in a manner so that said assessment result includes a plurality of said assessment values that each correspond to a respective said category.

18. A method according to claim 17, wherein each said category is one of: development environment, system environment, system controls, maintenance testing, user acceptance testing, implementation, and post implementation review.

19. A method according to claim 16, wherein said computer program is operable when executed to generate a report which includes said assessment result.
